(19) United States
(12) Patent Application Publication
(10) Pub. No.: US 2025/0160379 A1
(43) Pub. Date: May 22, 2025

(54) PLANT-ONLY BULKING AND TEXTURIZING AGENTS FOR FOOD PRODUCTS

(71) Applicant: The Live Green Group, Inc.,, Middletown, DE (US)

(72) Inventors: Sasikanth Chemalamudi, San Fernando (CL); Priyanka Srinivas, San Fernando (CL)

(73) Assignee: The Live Green Group, Inc.,, Middletown, DE (US)

(21) Appl. No.: 18/841,717

(22) PCT Filed: Feb. 22, 2023
(86) PCT No.: PCT/IB2023/051614

§ 371 Date: Aug. 27, 2024

Related U.S. Application Data
(60) Provisional application No. 63/314,542, filed on Feb. 28, 2022.

(30) Foreign Application Priority Data
Feb. 28, 2022 (US) 63/314542
Feb. 22, 2023 (WO) PCT/IB2023/051614

(51) Int. Cl. A23L 29/30; A23J 3/14; A23L 19/00; A23L 29/212; A23L 33/115; A23L 33/21

(52) U.S. Cl. CPC A23L 29/30; A23J 3/14; A23L 19/09; A23L 29/212; A23L 33/115; A23L 33/21

(57) ABSTRACT

A plant-only bulking and texturizing system for food products is provided. The bulking and texturing system is prepared by mixing one or more plant-derived category of ingredients such as a plant-derived source of fat, a fruit puree, a source of fiber and protein, a source of starch, a source of cream and one or more sugars and/or sugar replacements in a blender at 18000-28000 RPM, at about 23° C. to 30° C. to obtain a first homogeneous mixture and pasteurizing the first homogeneous mixture by continuous mixing for about 15-30 minutes at a temperature of 68-75 degrees Celsius to obtain the plant-only bulking and texturing system for food products. The bulking and texturizing system may be incorporated individually or in combination in the system in a frozen food product (e.g., a plant-only ice cream) along with one or more other plant-derived ingredients or systems.

### CROSS-REFERENCE TO RELATED APPLICATIONS

This application claims priority to the U.S. Provisional Application No. 63/314,542, filed on Feb. 28, 2022, titled “PLANT-ONLY BULKING AND TEXTURIZING AGENTS FOR FOOD PRODUCTS” and PCT Provisional Patent Application No. PCT/IB2023/051614, filed on Feb. 22, 2023, titled “A PLANT-ONLY BULKING AND TEXTURIZING SYSTEM FOR FOOD PRODUCTS AND METHODS OF PREPARATION THEREOF” and is incorporated herein by reference.

### BACKGROUND

### Technical Field

The disclosed embodiment relates generally to food composition and, more particularly, to plant-only bulking and texturing system for food products that replaces synthetic or artificial food additives, such as those used in frozen dessert food products.

### Description of the Related Art

Many conventional food products and food dessert products, contain natural or synthetic food additives to serve as stabilizers, preservatives, sweeteners, and emulsifiers (e.g., for dairy products) to provide desired flavors, sweetening, textures, appearance, consistency and/or uniform blending or homogeneity to the food product when several different components or ingredients are combined to form the food product. Some examples of food additive sweeteners include acesulfame potassium, high fructose corn syrup, polysorbate 60/80, sucralose, and dextrose. Other example forms of food additives include silicon dioxide, sodium benzoate, sodium nitrite, artificial food color dyes, etc. Many such additives (particularly synthetic additives) can be harmful to some people if consumed over prolonged periods of time. The industry uses more than 7,000 synthetic and ultra-processed additives even though nature offers more than 10,000,000 compounds from more than 450,000 plants. Traditional bulking and texturing additives used in the industry include, among others, agar, alginates, guar gum, methylcellulose, polydextrose and mannitol.

In addition, many dessert products and frozen dessert products (e.g., ice cream, sherbet, frozen yogurt, etc.), tend to contain dairy and/or eggs, which can be undesirable for some people (e.g., to some who are lactose intolerant or have a milk or dairy allergy). For people interested in a plant-based or vegan diet, this limits the variety of available dessert products on the market.

It would be desirable to provide a non-dairy dessert or other non-dairy food product that is plant-only and minimizes or avoids the use of bulking and texturing additives outside of a plant genus while ensuring desirable flavor, texture, appearance, and taste.

### SUMMARY

A plant-only bulking and texturing system for a plant-only food product is provided. The bulking and texturing system comprising one or more plant-derived category of ingredients such as a plant-derived source of fat, a fruit puree, a source of fat, a source of fiber and protein, a source of starch, a source of cream and one or more sugars and/or sugar replacements.

According to an aspect of the disclosed embodiments, a plant-only bulking and texturizing system for food products is provided. The composition includes a) 10-50% by weight of a sugar or sugar replacement source, b) 3-15% by weight of a fat source, c) 1-20% by weight of a fruit puree source, d) 5-15% by weight of a fiber and protein source, e) 3-15% by weight of a starch source, and f) 3-15% by weight of a cream source.

According to an embodiment, the sugar or sugar replacement source is selected from Banana, monk fruit powder, maple syrup, Custard apple, Raisins, Durian, Pears, Prunes, Sapodilla, Agave, Dried apricots, Date palm, Mangosteen, Barhi dates or similar/combinations thereof.

According to another embodiment, the fat source is selected from Avocado, Sunflower oil, Olive oil, mango kernel fat, Peanut oil, palm kernel oil, soybean oil, safflower oil, cocoa butter, corn oil, flaxseed oil, sesame oil or similar/combinations thereof.

According to yet another embodiment, the fruit puree is selected from Banana, Apple Puree, Avocado Puree, Pear Puree, Muskmelon Puree, Papaya Puree, Prunes Puree, apricot, mango puree, dragon fruit puree or similar/combinations thereof.

According to yet another embodiment, the fiber and protein source are selected from Chickpea, pinto beans, Corn fiber, black lentil, Citrus fiber, Balangu seed fiber, Psyllium fiber, Quince seed flour, Oat fiber, wheat germ, artichoke fiber, Pea fiber, Chicory root fiber or similar/combinations thereof.

According to yet another embodiment, the starch source is selected from Tapioca, Jackfruit seed starch, Taro starch, Yam starch, Arrowroot starch, Potato starch, Rice starch, Cassava starch, wheat starch, sweet potato starch or similar/combinations thereof.

According to yet another embodiment, the cream source is selected from Coconut cream, rice cream, cashew cream, sesame seeds cream, cassava cream, oat milk cream, white bean cream, tofu cream, three leaf yam cream, sweet potato cream, sunflower seeds cream or similar/combinations thereof.

According to yet another embodiment, the food product is a frozen dessert product, soft candies, Compound chocolates, Prebiotic cheese, Low calorie foods (meal replacement, pastries, breads), Low calorie frozen desserts and Non-dairy instant beverage powder.

According to yet another aspect of the disclosed embodiments, a method of preparing a plant-only bulking and texturing system for food products is provided. The method includes (i) mixing a) 10-50% by weight of a sugar or sugar replacement source, b) 3-15% by weight of a fat source, c) 1-20% by weight of a fruit puree source, d) 5-15% by weight of a fiber and protein source, e) 3-15% by weight of a starch source, and f) 3-15% by weight of a cream source in a blender at 18000 to 28000 RPM at about 23° C. to 30° C. for a suitable time to obtain a first homogeneous mixture; and (ii) pasteurizing the first homogeneous mixture by continuous mixing for about 15-30 minutes at a temperature of 68-75 degrees Celsius to obtain the plant-only bulking and texturing system for food products.

According to an embodiment, the fruit puree source is immersed in lemon juice for about 15 minutes before mixing.

According to another embodiment, the method comprises mixing the plant-only bulking and texturizing system with the food products to produce the bulking and texturizing effect to the food products.

According to yet another embodiment, the food product is a frozen dessert product, soft candies, Compound chocolates, Prebiotic cheese, Low calorie foods (meal replacement, pastries, breads), Low calorie frozen desserts and Non-dairy instant beverage powder.

According to yet another embodiment, the sugar or sugar replacement source is selected from Banana, monk fruit powder, maple syrup, Custard apple, Raisins, Durian, Pears, Prunes, Sapodilla, Agave, Dried apricots, Date palm, Mangosteen, Barhi dates or similar/combinations thereof.

According to yet another embodiment, the fat source is selected from Avocado, Sunflower oil, Olive oil, mango kernel fat, Peanut oil, palm kernel oil, soybean oil, safflower oil, cocoa butter, corn oil, flaxseed oil, sesame oil or similar/combinations thereof.

According to yet another embodiment, the fruit puree is selected from Banana, Apple Puree, Avocado Puree, Pear Puree, Muskmelon Puree, Papaya Puree, Prunes Puree, apricot, mango puree, dragon fruit puree or similar/combinations thereof.

According to yet another embodiment, the fiber and protein source are selected from Chickpea, pinto beans, Corn fiber, black lentil, Citrus fiber, Balangu seed fiber, Psyllium fiber, Quince seed flour, Oat fiber, wheat germ, artichoke fiber, Pea fiber, Chicory root fiber or similar/combinations thereof.

According to yet another embodiment, the starch source is selected from Tapioca, Jackfruit seed starch, Taro starch, Yam starch, Arrowroot starch, Potato starch, Rice starch, Cassava starch, wheat starch, sweet potato starch or similar/combinations thereof.

According to yet another embodiment, the cream source is selected from Coconut cream, rice cream, cashew cream, sesame seeds cream, cassava cream, oat milk cream, white bean cream, tofu cream, three leaf yam cream, sweet potato cream, sunflower seeds cream or similar/combinations thereof.

According to yet another embodiment, the food product is a frozen dessert product, soft candies, Compound chocolates, Prebiotic cheese, Low calorie foods (meal replacement, pastries, breads), Low calorie frozen desserts and Non-dairy instant beverage powder.

According to yet another embodiment, physical characterization data associated with the ingredients of the bulking and texturing system comprising the sugar or sugar replacement source, the fat source, the fruit puree source, the fiber and protein source, the starch source, and the cream source is stored in a database. A machine learning model determines a unique combination of ingredients based on the physical characterization data to prepare the bulking and texturing system.

According to yet another embodiment, the physical characterization data of the ingredients comprise functional properties that comprise emulsification properties, stabilization properties, gelling properties, fat-replacement properties, ayurvedic and/or other holistic properties, physicochemical properties that comprise pH, viscosity, moisture content, density, mechanical properties that comprise adhesive strength, tensile strength, shear resistance, chemical and/or molecular descriptor properties that comprise bio-active/bioavailability properties, molecular structure, phytonutrient properties, sensorial properties that comprise taste, smell, color, texture, mouth feel, and nutritional information that comprises macronutrient/micronutrient properties.

Several aspects of the disclosed embodiments are described below with reference to examples for illustration. However, one skilled in the relevant art will recognize that the disclosed embodiments can be practiced without one or more of the specific details or with other methods, components, materials, and so forth. In other instances, well-known structures, materials, or operations are not shown in detail to avoid obscuring the features of the disclosed embodiments. Furthermore, the features/aspects described can be practiced in various combinations, though only some of the combinations are described herein for conciseness.

### BRIEF DESCRIPTION OF THE DRAWINGS

Example embodiments of the disclosed embodiments will be described with reference to the accompanying drawings briefly described below.

FIG. 1 illustrates a flow chart of a method of preparing a plant-only bulking and texturing system for food products according to the aspect of the present disclosed embodiments.

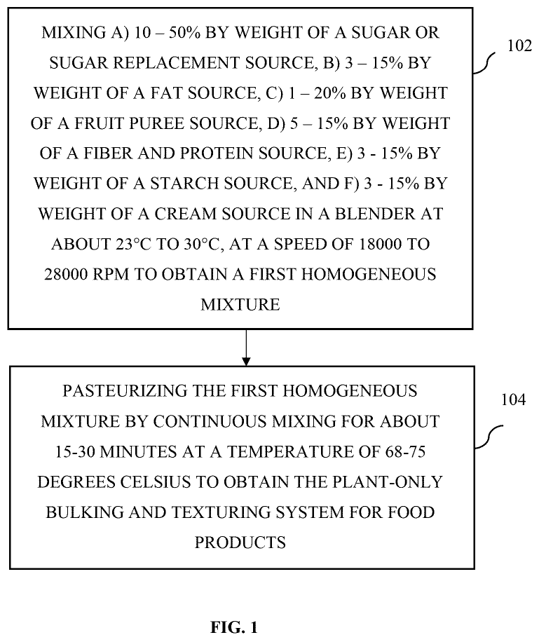

In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE DISCLOSED EMBODIMENTS

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced items. Further, the use of terms “first”, “second”, and “third”, and the like, herein do not denote any order, quantity, or importance, but rather are used to distinguish one element from another. Further, the terms “comprising,” “including,” “having,” and the like, as used with respect to embodiments of the present disclosure, are synonymous. As used herein, the terms “agent,” “component,” or “ingredient” are used interchangeably and refer to a particular item that includes one or more chemical compounds (e.g., a food item from one or more plants that comprise one or more naturally occurring chemical compounds).

The term “component” or “ingredient” as used herein, refers to a particular item that includes one or more chemical compounds, i.e., edible compounds sourced from plants, fungi or algae that comprises one or more naturally occurring chemical compounds.

Alternative embodiments of the present disclosure and their equivalents may be devised without parting from the spirit or scope of the present disclosure. It should be noted that any discussion herein regarding “one embodiment”, “an embodiment”, “an exemplary embodiment”, and the like indicate that the embodiment described may include a particular feature, structure, or characteristic, and that such particular feature, structure, or characteristic may not necessarily be included in every embodiment. In addition, references to the foregoing do not necessarily comprise a reference to the same embodiment. Finally, irrespective of whether it is explicitly described, one of ordinary skill in the art would readily appreciate that each of the particular features, structures, or characteristics of the given embodiments may be utilized in connection or combination with those of any other embodiment discussed herein.

As used herein, the singular forms “a”, “an”, and “the” include both singular and plural referents unless the context clearly dictates otherwise. By way of example, “a dosage” refers to one or more than one dosage.

The terms “comprising”, “comprises” and “comprised of” as used herein are synonymous with “including”, “includes” or “containing”, “contains”, and are inclusive or open-ended and do not exclude additional, non-recited members, elements or method steps.

All documents cited in the present specification are hereby incorporated by reference in their totality. In particular, the teachings of all documents herein specifically referred to are incorporated by reference.

Example embodiments of the disclosed embodiments are described with reference to the accompanying figures.

In the drawings, like reference numbers generally indicate identical, functionally similar, and/or structurally similar elements. The drawing in which an element first appears is indicated by the leftmost digit(s) in the corresponding reference number.

### Definitions

“Bulking” refers to increasing the volume or weight of a product without affecting the overall taste and aroma of the product
“Texturizing” refers to improving the overall consistency, texture by enhancing features like creaminess, viscosity, mouthfeel and taste
“Fat” refers to a type of lipid consisting of triesters of glycerol and fatty acids or triglycerides.
“Fruit puree” refers to making fruit or vegetables into a thick, smooth sauce by crushing.
“Derived sugars” refers to modified monosaccharides.
“Fiber” refers to the portion of plant-derived food that cannot be completely broken down by human digestive enzymes.
“Proteins” refers to large biomolecules and macromolecules that comprise one or more long chains of amino acid residues.
“Starch” refers to a polymeric carbohydrate consisting of numerous glucose units.
“Cream” refers to a thick yellowish-white liquid.
“Emulsifier” refers to an agent used to help mix two substances that typically separate when they are combined.
“Thickener” refers to a substance that increases the viscosity of a liquid without substantially changing its other properties.
“Stabilizer” refers to an additive to food that helps to preserve its structure.
“Flavoring agent” refers to an additive that provides an additional taste or flavor.
“Pasteurization” refers to the partial sterilization of a product to make it safe for consumption and improve its keeping quality.
“Homogeneous mixture” refers to a mixture that has the same proportions of its components throughout a given sample.
“Blender” refers to an appliance used to mix, crush, purée or emulsify food and other substances.
“Machine learning model” refers to computer software designed to recognize patterns or behaviors based on previous experience or data.
“Plant-derived” refers to ingredients extracted from a plant.
“Plant-only” products disclosed herein, as opposed to products labeled as “plant-based,” and the like, refer to food products whose ingredients, apart from any significant amount of water added, are derived solely from sources outside of the animal kingdom, e.g., from plants, fungi, or algae. That is, “plant-only” may refer to any composition, formulation, system or the entire food product, that is produced, developed, or otherwise obtained directly or indirectly from one or more plants, fungi, or algae, is not synthetic, and is only minimally processed for production, e.g., cleaned, dried, pulverized, etc.

The term “food product” refers broadly to any edible food or product, raw or cooked, savory or sweet, whether intended for human or animal consumption; a food product may be edible although not intended to be consumed on its own but, rather, incorporated into a second (or third) food product that is considered a consumable. In certain embodiments, while some of the water content of a food product may be derived from a plant source, water may also be added to the product from an external source. For example, in scenarios in which a plant-only system or plant-only food product is in the form of a gel or liquid, it is further understood that water can be included as solvent or liquid carrier for the plant-only system, ingredient or food product, where any amount of water (some or all) within the system, ingredient or food product may or may not be derived from a plant source. In the disclosed embodiments, apart from externally-sourced water, the plant-only food product consists entirely of ingredients derived from plants, fungi or algae, excluding any component or ingredient that is: (i) dairy-based or otherwise derived from any member of the animal kingdom; and (ii) more than minimally processed; and (ii) synthetic.

The Applicant, Live Green Company, is the market maker of the Plant-only category, which means that all the animal, synthetic and ultra-processed ingredients are replaced by plant-derived ingredients with superior nutritional profiles without impacting the original organoleptic properties.

A plant-only food product or formulation that is free from dairy and other animal-based ingredients is described herein that has desirable flavor, taste, texture, homogeneity, consistency, color and appearance so as to be aesthetically pleasing prior to consumption. The terms “plant-derived is used,” in this disclosure to refer to any ingredient, or component of a food product that is derived or extracted or obtained from plants with minimal processing. The term plant-only is used in this disclosure to refer to a system, composition, formulation or the entire food product itself, that is produced, developed or otherwise obtained directly or indirectly from one or more of the plant-derived ingredients, component that is obtained from plants with minimal processing. Although a plant-only, food product may consist of materials that are 100 percent sourced from one or more plants, the term also encompasses food products that may contain components or ingredients that are not obtained from plants. For example, while some of the water content of a food product may be derived from a plant source, water may also be added to the product from an external source. For example, in scenarios in which a plant-only system or plant-only food product is in the form of a gel or liquid, it is further understood that water can be included as solvent or liquid carrier for the plant-only system or plant-only food product, where any amount of water (some or all) within the system or food product may or may not be derived from a plant source. In some embodiments, apart from added water, the plant-only food product consists entirely (100%) of components or ingredients from a plant genus (i.e., photosynthetic eukaryotes from the kingdom Plantae), and further excluding any component or ingredient that is dairy-based, that is from the animal genus (including animal fats and animal proteins) and also excludes any synthetically derived component or ingredient. The plant-derived ingredients of the food product described herein replace conventional animal-based ingredients, including milk, cream and eggs, as well as conventional additives such as gums, stabilizers, emulsifiers, preservatives, anti-freezing and anti-caking agents, binders, etc. The product formed solely from plant-derived ingredients is further free from gluten, soy, cholesterol and trans fatty acids.

The selection of specific plant-derived ingredients, or specific combinations (i.e., systems) of plant-derived ingredients provide effective functionalities such as emulsifiers, stabilizers, texturizing and thickening, fat replacement, sugars or other sweeteners, anti-freezing properties, anti-caking properties, etc., for the food product without the need to add such conventional, non-plant-derived additives.

As used herein, the terms “agent,” “component,” or “ingredient” are used interchangeably and refer to a particular item that includes one or more chemical compounds (e.g., a food item from the plant species that comprises one or more naturally occurring chemical compounds). The term “plant-derived”, as used herein, refers to a product or formulation (e.g., food product or food formulation).

### Functionality and Parameters

TABLE 1
Parameter ranges associated with ingredients of
the plant-only bulking and texturing system

| Functionalities | Parameters & Ranges | | | |
|---|---|---|---|---|
| Sugars or sugar | Type of | Glycemic | elative | Viscosity |
| replacements | carbohydrates/ | index | sweetness | Should |
| | sweetener response: high | Low GI: 1 to | with | be less |
| | intensity, longer | 55. Medium | sucrose. | viscous. |
| | time. | GI: 56 to 69 | | Below |
| | | | | 600 cP |
| Plant-derived fat | HLB score: Veg. | Emulsion | at | |
| | oils should have 6 | stability: | content: | |
| | (required) | 30-70% | 16% | |
| Fruit puree | Flow behavior | Should be | | |
| | index should be less | non- | | |
| | than 1 i.e shear | newtonian | | |
| | thinning (n < 1) | | | |
| Fiber and protein | Water | Zeta | H: | Foaming |
| source | absorption/retention | potential −40 | 4 or more | capacity: |
| | capacity (WAC): | to +40 mV | than 5 | 38-120% |
| | 4-25 g/g | | | or more |
| Plant-derived starch | Pasting Temperature: | Peak/Maximum | WAC/WHC: | Swelling |
| | 68.6-69.3° C. | viscosity (BU) | 415.13- | power/ |
| | | 0.1 and 0.9 | 595.26% | Hydration |
| | | Pa · s, at a shear | | capacity: |
| | | rate of 115 s−1 | | 20.76- |
| | | | | 26.92% |
| | | | | Amylose |
| | | | | content: |
| | | | | 15-30% |
| Plant-derived cream | Fat percentage: | pH: 4.5-6 | Emulsion | |
| | 16-50% | | stability | |
| | | | 0-96% | |

The ingredients of the plant-only bulking and texturing system may be selected for inclusion in a food product based on the ingredient's functionality, such as altering sugar content, increasing viscosity, increasing structural stability, increasing creamy texture, increasing the number of soluble fibers and protein, increasing healthy fats, increasing gelatinization, and increasing the water holding capacity. The ingredient is selected based on the ingredient's physicochemical properties, such as energy provided, melting, boiling, freezing and recrystallization points, physical phase, pH, viscosity, molecular weight, effects on overrun, viscosity, titratable acidity, and melting resistance. The ingredients of the plant-only bulking and texturing system may be chosen for their physiochemical properties such as energy provided, melting, boiling, freezing and recrystallization points, physical phase, pH, TSS, viscosity, molecular weight, effects on overrun, viscosity, titratable acidity, and melting resistance. The ingredients of the plant-only bulking and texturing system may be chosen for their ayurvedic properties, where the ayurvedic properties may include, but are not limited to Virya, Vipaka, Rasa, Guna.

The physical characterization data associated with the ingredients of the bulking and texturing system is stored in a database. A machine learning model determines a unique combination of ingredients based on the physical characterization data to prepare the bulking and texturing system. The machine learning model identifies plant-based ingredient replacements based on the parameters and ranges to give the list of ingredients for each possible functionality.

### Example Embodiments

The disclosed embodiments are illustrated in further detail by the following non-limiting examples.

TABLE 2
Percent by weight of each of the preferred, essential,
bulking and texturing categories of ingredients
in the bulking and texturizing system.

| | Preferred Weight |
|---|---|
| | Percent of System |
| Preferred Bulking and Texturizing System | (based upon total weight |
| Ingredients | of mixture) |
| Sugars or sugar replacements (e.g., Banana, | 10-50 |
| monk fruit powder, maple syrup) | |
| Plant-derived fat (e.g., Avocado) | 3-15 |
| Fruit puree (e.g., Banana) | 1-20 |
| Fiber and protein source (e.g., legumes such as | 5-15 |
| peas) | |
| Plant-derived starch (e.g., Tapioca) | 3-15 |
| Plant-derived cream (e.g., Coconut cream) | 3-15 |

A particularly effective combination of plant-derived bulking and texturizing ingredients, including the ingredients as described herein, are combined as shown in Table 2 above, and form the bulking and texturizing system that may be, in whole or part, added to one or more other ingredients to form a plant-based ice cream or other frozen dessert. Together, two or more of the listed ingredients or their plant-derived equivalents comprise a combination of bulking and texturizing systems (i.e., a “bulking and texturizing system”).

Although Table 2 provides a preferred list of bulking and texturing ingredients, substitutions for these ingredients in the system may be made in alternative embodiments for compliance with certain dietary requirements; without limitation, such as food sensitivities and food allergies. For example, peanut allergies would dictate a formulation free from peanuts (a type of legume) used as a fiber source so that an anaphylactic reaction would not be triggered the consumer with such allergies. A second example would be a formulation containing low sugar but relatively higher content of a plant-derived, low-calorie, low-glycemic index sugar replacement, which may be indicated for diabetic diets.

The selection of specific plant-derived ingredients, or specific combinations (i.e., systems) of plant-derived ingredients provide effective functionalities such as emulsifiers, stabilizers, texturizing and thickening, fat replacement, sugars or other sweeteners, anti-freezing properties, anti-caking properties, etc., for the food product without the need to add such conventional, non-plant-derived additives. As used herein, the terms, “component,” or “ingredient” may be used interchangeably and refer to a particular item that includes one or more chemical compounds (e.g., a food item from the plant species that comprises one or more naturally occurring chemical compounds). The term “plant-only”, as used herein, refers to a product or formulation (e.g., food product or food formulation) that may be 100% derived or nearly 100% derived from members of a plant genus.

In example embodiments, the plant-only food product includes a combination of components or ingredients from a plant genus that render the combination (in the amounts as indicated) particularly suitable as a bulking and texturizing system that can be combined with other components or ingredients from a plant genus to form a specific form of food product. Some examples of plant-only food products that incorporate the bulking and texturizing system as described herein include plant-only frozen dessert products, such as plant-only ice cream, and any other plant-only food products containing plant-derived fats and/or other organic compounds that are insoluble and/or immiscible in aqueous based formulations.

In other example embodiments, specific and unique combinations of plant-derived ingredients are combined with the plant-derived bulking and texturizing system to form dessert products such as ice cream having properties very close in similarity with conventional (dairy based) frozen dessert products.

TABLE 3
preferred composition in weight percentages of
the plant-derived ingredients or systems in a
final ice cream or frozen dessert food product.

| Food Product Component or | Preferred Weight Percent |
|---|---|
| System | Contribution |
| Water | 55%-65% |
| Bulking and texturizing system | 8%-10% |
| Sugars & Sugar replacements | 10%-15% |
| Fat replacement system | 2%-5% |
| Dairy replacement system | 5%-15% |
| Emulsifier & Stabilizer | 0.5%-5% |
| Anti-Freezing & Anti-Caking | 0.5%-5% |
| system | |

The bulking and texturizing system is one of several components that are included in an ice cream or other frozen dessert food product. As seen from Table 3, the bulking and texturizing system disclosed herein preferably comprises only 8 to 10 percent of the final frozen dessert food product.

Table 3 shows the preferable composition in weight percentages of the plant-derived ingredients or systems in the final ice cream or frozen dessert food product. Where individual ingredients are found in more than one system (e.g., sugar and sugar replacements are a separate component in Table 3, but also are found in the bulking and texturizing system and contribute to the range indicated for that system), the actual weight percent contribution of a particular ingredient (e.g., sugar) across all components or systems may not be evident from the data presented in Table 3.

In the disclosed embodiments, the bulking and texturizing system (which may vary by ingredients and amounts depending on the final food product desired) is incorporated into each food product embodiment, each plant-derived ingredient or system present (fat replacement system, emulsifier and stabilizer systems, dairy replacement system, sugars and sugar replacements, and anti-freezing and anti-caking systems) in an amount within the range(s) indicated in Tables 2 and 3. Additional ranges for the systems in Table 3 are detailed below.

In some embodiments of the bulking and texturizing system, the ingredients comprise a source of fiber that is preferably present in the system in an amount within the range of 5 to 10 percent by weight of the system. In certain embodiments, the source of fiber is a legume. In other embodiments the legume is peas or chickpeas. In certain embodiments the bulking and texturizing ingredients comprises a plant-derived sugar and/or a sugar replacement, which is preferably present in the system in an amount within the range of 10 to 40 percent by weight of the system.

In other embodiments, the sugar or sugar replacement comprises a bulking agent. In certain embodiments, the sugars and/or sugar replacements include any one or more of maple syrup, banana, and monk fruit.

In other embodiment the plant-derived ingredient of the bulking and texturizing system comprises banana and is preferably present in an amount within the range of 1 to 10 percent by weight of the system. In still another embodiment avocado is preferably present in the system in an amount of 3 to 10 percent, and in another embodiment, tapioca starch is preferably present in the system in an amount within the range of 3 to 10 percent by weight of the system.

In one embodiment coconut cream is present in the bulking and texturizing system in an amount within the range of 3 to 10 percent by weight of the system.

In certain embodiments a food product is comprised of one or more plant-derived bulking and texturizing ingredients, wherein the bulking and texturizing ingredient of the system is selected from the group consisting of a sugar, banana, avocado, a fiber source, tapioca starch, coconut cream, and a sugar replacement wherein the ingredient is present in an amount by weight of the system according to Table 2. In certain other embodiments the food product is a frozen dessert product. In some embodiments the food product is further compromised of one or more plant-derived ingredients or systems selected from the group consisting of a fat replacement system, a dairy replacement system, an emulsifier and stabilizer system, and an anti-freezing and anti-caking system.

In other embodiments a frozen dessert food product comprises a mixture of two or more plant-derived ingredients that include sugar, banana, avocado, coconut cream, tapioca starch, a fiber source, and/or a sugar replacement. In certain embodiments the frozen desert food product comprises both the bulking and texturizing system (comprising the individual ingredients listed in Table 2), as well as one or more other plant-only systems such as a sugar or sugar replacement, a fat replacement system, a dairy replacement system, an emulsifier and stabilizer system, and an anti-freezing and anti-caking system, as listed in Table 3 with their preferred ranges. In some embodiments the frozen dessert food product is a plant-only ice cream food product.

Selection of a specific combination of ingredients for plant-only systems and products (e.g., bulking and texturizing systems and frozen dessert products as described herein) was determined using a proprietary machine learning (ML) platform, which blends ancestral wisdoms of plant nutrition with biotechnology and ML to analyze the plants and compounds nature offers. The platform utilizes algorithms and includes a database with a significant number of ingredients (e.g., 50,000-100,000 ingredients) and relevant physical properties associated with such ingredients. For example, physical characterization data and information about each ingredient for some or all the ingredients in the database include, without limitation, functional properties (e.g., emulsification properties, stabilization properties, bulking properties, texturizing properties, gelling properties, fat-replacement properties, etc.). Ayurvedic and/or other holistic properties, physicochemical properties (e.g. pH, viscosity, moisture content, density, etc.), mechanical properties (e.g. adhesive strength, tensile strength, shear resistance, etc.), chemical and/or molecular descriptor properties (e.g., bio-active/bioavailability properties, molecular structure, phytonutrient properties, etc.), sensorial properties (e.g., taste, smell, color, texture, mouth feel, etc.), and nutritional information (e.g., macronutrient/micronutrient properties, etc.) are also considered in the proprietary system to give optimal results in terms of functionality, health and sustainability. Based upon the known properties of ingredients in the database, the desired properties for the food product or formulation, and one or more algorithms associated with the proprietary machine learning platform, a unique combination of plant-derived components or ingredients was determined to yield an effective formulation that can be used as a bulking and texturizing system for food based products, such as forming a desirable food product or formulation that is effective as a substitute for conventional dairy based ice cream and other frozen dessert products.

As noted, the proprietary system, identifies natural alternatives, i.e., plant-derived alternatives to synthetic, artificial, and animal-derived ingredients, and incorporates, among other things, traditional knowledge known as Ayurvedic medicine. Ayurvedic medicine and its diet principles have been practiced for many thousands of years. This ancient system, among other things, categorizes food by its medicinal properties and desired effects; thus, the proper application of Ayurvedic principles requires knowledge of the self-one's dominant energy, also known as dosha—to prescribe the most advantageous categories of foods from which to choose for an individual's diet. Categories of Ayurvedic properties include but are not limited to Virya (hima/sheeta-cold), Vipaka (Madhura-sweet), Rasa (Madhura-sweet), and Guna (ruksa-dry; or guru-heavy). The information recommended by the proprietary system previously described permits one to choose between hundreds of alternatives based on agents intended to alter a variety of properties to give optimal results for functionality, health and sustainability.

### Plant-Only Bulking and Texturizing System

Bulking agents increase the volume or weight of the product but do not actually affect the overall taste and aroma of food products; it improves the structural aspects; it also promotes aeration and improves the nutritional profile. A texturizing agent improves the overall consistency, texture by enhancing features like creaminess, viscosity, mouthfeel, and taste. Individual plant-derived ingredients may contribute both bulk and texture.

A food product as described herein functions as a bulking and texturizing_system (also referred to as “the system”) comprises a combination of the plant-derived components or ingredients. The system is 100% plant-derived (ingredients are only or primarily obtained from a plant genus) and comprises the following essential ingredients: avocado (e.g., in the form of a pulp or paste), banana (e.g., in the form of a pulp or paste), coconut cream, tapioca starch, fiber and protein (e.g., legumes) and a sugar, and/or sugar replacement).

Avocado is provided as a bulking and texturizing ingredient in the system due to its rich content of oleic acid and other monounsaturated fatty acids (MUFAs), and its creamy texture and taste feel. The MUFAs in avocado can function as natural surfactants that, when activated (e.g., when the avocado is mashed or pulverized to form a pulp or fine paste), are highly effective for use in oil and water emulsions. Avocado is further nutrient and phytochemical dense, including fat soluble vitamins such as vitamins A, D, K and E. In particular, avocado contain a high total fat content (about 15% by weight of the avocado), a significant portion of which are MUFAs (about 9.8% by weight), a high phytosterol content (about 57 mg/100 g) and is high in dietary fiber as well as including vitamins A, C, D, K, E and B complex and also minerals such as potassium and magnesium. Avocado pulp contains from 67 to 78% by weight (i.e., by weight of the pulp) moisture, 13.5 to 24% by weight lipids, 0.8 to 4.8% by weight carbohydrates, 1.0 to 3.0% by weight protein, 0.8 to 1.5% by weight ash, and 1.4 to 3.0% by weight fiber, and the avocado pulp further has an energy density between 140 and 228 kcal.

The avocado fruit further has a soft and mushy texture that renders it desirable for a variety of different food products. Avocado fruit used to form the agent can be provided as pulp or a paste that is obtained by separating the flesh of the avocado from its skin and seed. The amount of avocado provided in the system as well as any food product formed with the system will affect the viscosity of the product, where an increase in amount of avocado in the product will increase the fiber and cause an increase in viscosity of the system and food product, reducing melting time and overrun. Avocados have both soluble and insoluble fibers, but the soluble fibers improve the texture of ice cream. Avocado promotes the Ayurvedic properties of Rasa (Tikta-bitterness) and Guna (Guru-heavy).

### Plant-Derived Frozen Dessert/Ice Cream Food Products

When using the bulking and texturizing system for a plant-only frozen dessert product such as plant-only ice cream, some further plant-derived bulking and texturizing ingredients or combination can be combined with one or more additional plant-derived ingredients to enhance properties of the plant-only frozen dessert product such as energy content, pH, viscosity, flavor profile, melting resistance, freezing/recrystallization points, etc. For example, plant-only fat replacement system, dairy replacement system, anti-freezing and anti-caking system may be combined with the bulking and texturizing system in varying amounts to create thousands of combinations of 100% plant-derived ingredients/agents, to create 100% plant-only, or nearly 100% plant-only, frozen desserts.

Additional plant-derived ingredients that have been found essential, when combined with the agent described herein, in forming unique plant-only ice cream or other frozen dessert food products are as follows: plant-derived cream (e.g., coconut cream, cashew cream, etc.), plant-derived starch (e.g., tapioca starch, potato starch, rice starch, etc.), one or more additional plant-derived proteins (e.g., lupin protein), one or more additional types of plant-derived fiber (e.g., lupin fiber), one or more additional plant-derived oils or fatty acids (e.g., sunflower oil, olive oil, etc.), one or more additional plant-derived sugars and/or sugar replacements (e.g., monk fruit powder, maple syrup, banana, etc.), and one or more plant-derived fat replacement ingredients, and one or more dairy replacement ingredients, and one or more plant-derived anti-freezing and/or anti-caking ingredients (e.g., sugar beet). The essential ingredient formulation can comprise the system and any one or more (e.g., any two or more, any three or more, etc.) of these further additional plant-derived ingredients as described herein. In an example, a particularly useful formulation was determined as including the system and all the additional essential ingredients as described herein.

For example, additional proteins and fiber solely derived from a plant genus, such as pea or lupin proteins, and pea or lupin fiber (derived from lupin beans from the Lupinus sub-genus within a plant genus) were determined to enhance the properties of the plant-only bulking and texturizing system with regard to plant-only frozen dessert products. Custard apple fruit can be made into a pulp; it provides both sweetness, creaminess and fiber in the form of pectin, the latter, which is beneficial to enhance gelling and stability of the food product to which they (or the complete system) are added.

The fiber content and polysaccharide fractions in the avocado, banana, plant-derived fiber and proteins (such as from chickpeas or other legumes), can be cryoprotective agents due to their water-binding capacity, gel-forming ability, texturizing, and thickening effects, thus providing anti-freezing properties for the ice cream product. The water binding capacity of the fiber limits the mobility of water molecules from the bulk aqueous phase to the ice crystal surface phase. The addition of fat rich ingredients (avocado, banana, coconut cream) and pectin source (sugar beet and custard apple) provide anti caking properties as they are responsible for the creamy and smooth texture of ice cream. They reduce the formation of large ice crystals and improve the mouth coating property.

Water is also combined with the ingredients to render the agent as an aqueous based formulation. While some water may be extracted from a plant source and provide another source of important nutrients, water is also sourced from purified water bottlers.

This unique combination of essential ingredients for a plant-only ice cream (or other frozen dessert) product was determined to provide certain functionalities for the ice cream product as noted in Table 4.

TABLE 4
Functionality of the bulking and texturizing ingredients for the plant-
only frozen food products (e.g., plant-only “ice cream”).

| | | | Ayurveda |
|---|---|---|---|
| Plant-derived | Compounds responsible for | Physicochemical | properties of |
| Ingredient | functionality | properties of ingredients | ingredients |
| Sugars and | Sugar replacements are not | Effect on melting | N/A |
| sugar | only sweeteners but also acts | resistance: Higher melting | |
| replacements | as a bulking agent and | rate due to low freezing | |
| from natural | provides a smooth mouthfeel. | point | |
| sources | Examples include, without | Recrystallization: Due to | |
| | limitation: monk fruit, maple | low freezing point, | |
| | syrup and banana. | recrystallization rates are | |
| | | very low. | |
| | | The freezing point is | |
| | | largely influenced by the | |
| | | type of sugar. The effects on | |
| | | the freezing point | |
| | | depression are related to the | |
| | | molecular weight. | |
| | | Disaccharides like sucrose | |
| | | and lactose have a similar | |
| | | influence on the freezing | |
| | | point depression. | |
| | | Monosaccharides like | |
| | | glucose and fructose have a | |
| | | much larger influence. | |
| | | A lower freezing point | |
| | | will lead to a lower ice | |
| | | fraction and to a decreased | |
| | | hardness in the food | |
| | | product. | |
| Fruit puree (e.g., | The soluble pectin fibers | pH - 4 to 6 | Rasa: Madhura |
| Banana) | present in banana increase the | TSS (brix) - 3.5 to | (Sweet), |
| | viscosity of the ice cream thus | 4.5 | Kashaya |
| | providing a creamy texture. | Viscosity (mPa s) - | (Astringent) |
| | The sugars present like | 84 to 91 | Guna: Guru |
| | sucrose, fructose, and glucose | Effect on overrun: The | (Heavy), |
| | provides bulk to the ice | polysaccharides contribute | Snigdha (Smooth) |
| | cream. | to the foam stability which | Virya: Hima (Cold) |
| | | leads to air adsorption in the | Vipaka: Madhura |
| | | ice cream. | (Sweet) |
| | | Effect on titratable | |
| | | acidity: There is decrease in | |
| | | the acidity as banana has | |
| | | less acidity. | |
| | | Effect on melting | |
| | | resistance: Melting time | |
| | | decreased with increased | |
| | | amounts of the banana pulp. | |
| Plant-derived | Has abundant in both soluble | Viscosity: Increasing | Rasa: Tikta (Bitter) |
| fat (e.g., | and insoluble fiber. The | amounts of avocado pulp | Guna: Guru |
| Avocado) | soluble fibers present in | increased the viscosity of | (Heavy) Snigdha |
| | avocado improves the texture | the ice cream. | (Oily/Smooth) |
| | of ice cream. | Melting time: Melting | Viraya: Hima (cold) |
| | | time decreased with | Vipaka: Madhura |
| | | increasing amounts of | (Sweet) |
| | | avocado pulp in the ice | |
| | | cream | |
| | | Overrun: Decreased with | |
| | | increasing amounts of | |
| | | avocado pulp in ice cream. | |
| Plant-derived | Coconut cream is rich in | Overrun: Addition of | Rasa: Madhura |
| cream (e.g., | healthy fats called medium- | coconut cream reduced the | (Sweet) |
| coconut cream) | chain triglycerides (MCTs) | overrun values of ice cream. | Guna: Hima/Sheeta |
| | and has a thick consistency. | Melting rate: Decreased | (Cold) Snigdha |
| | This in turn helped to | with the addition of coconut | (Oily) |
| | improve the creaminess and | Viscosity: | Virya: Hima/Sheeta |
| | thick consistency of ice | Addition of coconut | (Cold) |
| | cream. | increased the viscosity | Vipaka: Madhura |
| | | | (Sweet) |
| Plant-derived | Tapioca starch has an | Effect on viscosity: | Rasa: Madhura |
| starch (e.g., | amylopectin/amylose ratio of | The amylopectin present | (Sweet) |
| Tapioca) | 80:15. | helps in increasing the | Lavana (Salty) |
| | Pulpy texture was introduced | viscosity. Also, it restricts | Guna: |
| | to ice creams with the aid of | the crystal growth during | Virya: Hima/Sheeta |
| | highly cross-linked and | storage. | (Cold) |
| | gelatinization forming | Effect on melting | Vipaka: Madhura |
| | tapioca pregels. | resistance: The gelatinized | (Sweet) |
| | The total solids content in | starch contributes to the | |
| | tapioca contributes to the | higher melting resistance. | |
| | bulking of ice cream. | Effect on overrun: | |
| | | Optimized overrun is | |
| | | recorded due to the | |
| | | gelatinized starch | |
| Fiber source, | Peas and other legumes are a | Pea protein isolates | Rasa: Madhura |
| e.g., pea or | rich source of fiber and | help in achieving the desired | (Sweet), |
| chickpea, or | protein, Pea protein isolates | texture due to the | Tikta (Bitter) |
| other legume | contribute fiber-like | stabilization activity. | Guna: Hima (Cold), |
| (providing | functionality to the bulking | Due to the liquid | Tikta |
| soluble fiber | and texturizing system. | binding property of pea | Virya: |
| and in some | Soluble fiber in chickpeas, | protein, there is formation | Hima/Sheeta (Cold) |
| cases, protein, | e.g., known as raffinose, | of a stable gel network | Vipak: Madhura |
| that functions as | maximizes water holding | leading to immobilization of | (Sweet) |
| fiber) | capacity, which leads to | water molecules. | |
| | better freezing and smooth | Viscosity: Impact | |
| | texture of the ice cream. | of fibers and starch of | |
| | | chickpea seeds and pea | |
| | | protein leads to increase in | |
| | | viscosity. | |
| | | Overrun: The | |
| | | lowering in the overrun is | |
| | | due to the high viscosity of | |
| | | mixes which caused less air | |
| | | incorporation in the ice | |
| | | cream. | |
| | | Melting resistance: | |
| | | increased significantly as | |
| | | the percentage chickpea | |
| | | extract increases due to the | |
| | | impact of fibers and starch | |
| | | of chickpeas on the | |
| | | viscosity of ice cream. | |

Unique combination of essential ingredients for a plant-only ice cream or other frozen dessert products was determined to provide bulking and texturing functionalities, as noted in Table 4.

### Example of Forming a Plant-Only Ice Cream Product Including Essential Bulking and Texturizing Agent and Other Components

The agent formulation as well as combination of essential ingredients (as noted in Table 2 herein) can be formed by combining and mixing the ingredients in any suitable manner, any suitable order and any suitable combination(s). In the formation process, the avocado fruit and banana fruit may first be soaked (separately or together) in lemon juice and/or lime juice to minimize, prevent and/or delay enzymatic browning of these ingredients and prior to their combination with other plant-derived bulking and texturizing ingredients forming the bulking and texturizing system, and possibly additional ingredients forming the food product.

An example embodiment for the formulation of a plant-only frozen ice cream food product with the ingredients as set forth in Tables 2 and 3 is described as follows. All the plant-derived ingredients are obtained from fresh plant sources or minimally processed sources.

If using fresh plant sources for the system ingredients, the avocado and banana fruits are peeled, and the avocado fruit seed is removed. Both fruits are mashed into a pulp, paste or puree form and are uniformly mixed and combined in amounts to be at the same or similar weight percentage ratio with each other (e.g., about a 50:50 weight ratio). The combined pulp mixture is immersed in lemon juice and/or lime juice for a suitable time (e.g., about 15 minutes). The pulp is then separated from the lemon and/or lime juice prior to combination with the other agent ingredients listed in Table 2. Water may be added as necessary for processing, particularly if the sources of the ingredients are not fresh, but minimally processed.

In some embodiments, plant-derived protein (acting as fiber) and plant-derived fiber ingredients (e.g., lupin protein and lupin fiber) are combined along with plant-derived (e.g., tapioca) starch, plant-derived (e.g., coconut) cream, and other plant-derived sugars at ambient/room temperature (about 23° C. to about 30° C.) and mixed together in a suitable blender or turbo mixer at 18000 to 28000 RPM for a suitable period of time to obtain a uniform mixture of ingredients. This mixture is then pasteurized by continuous mixing for a suitable period of about 15-30 minutes and at a temperature of about 68-75° C.

Any further plant-derived ingredients are then added to the uniform mixture, with further mixing and homogenization of the ingredients via blender or turbo mixer. Upon sufficient homogenization of the mixture, the contents are further mixed in an ice cream machine that churned the mixture while it was being cooled until a temperature of about −8° C. is reached. Churning also facilitates aeration of the frozen ice cream product so as to generate a desired amount of ice crystallization and overrun in the final product. After this mixing, the product was further processed within a blast chiller that blows chilled air to rapidly cool the temperature of the product to about −22° C., thus forming the plant-only ice cream product.

The combination of each plant-derived bulking and texturizing ingredient with the other ingredients or systems (fat replacement, dairy replacement, anti-freezing and anti-caking, emulsifiers and stabilizers, etc.), when combined in the manner described herein, facilitate the formation of a plant-only (i.e., 100% or nearly 100% plant-derived ingredients) final ice cream food product or any other frozen dessert product that resembles conventional ice cream or other conventional frozen dessert products (i.e., dairy based ice cream and frozen dessert products) with regard to look, mouth feel, texture, appearance, melting conditions, consistency and, most importantly, taste.

A wide range of plant-only ice cream products or other plant-only frozen dessert products can be formed with the essential plant-derived ingredients as described herein.

In the disclosed embodiments, the weight percent of the system in the final food product produced will vary according to specific food product. Where water has been added to the formulation for any particular frozen dessert food product, its content in the food product ranges between about 45 to about 75 percent of the final weight of the food product, between about 45 to about 50 percent, between about 47 to about 53 percent, between about 50 to about 55 percent, between about 52 to about 58 percent, between about 55 and about 60 percent, between about 57 to about 63 percent, between about 60 to about 65 percent, between about 62 to about 68 percent, between about 65 and about 70 percent, between about 67 to about 72 percent, between about 70 and about 75 percent, between about 45 and about 55 percent, between about 45 to about 65 percent, between about 55 and about 65 percent, between about 55 and about 75 percent, and between about 65 and about 75 percent.

In embodiments where a bulking and texturizing system has been added to the formulation for any particular frozen dessert food product, its content in the food product ranges between about 5 to about 15 percent of the of the final weight of the food product, between about 5 to about 10 percent, between about 8 to about 13 percent, between about 10 to about 15 percent, between about 6 to about 8 percent, and between about 8 and about 10 percent.

In embodiments where a sugar and/or sugar replacement system has been added to the formulation for any particular frozen dessert food product, its content in the food product ranges between about 5 to about 20 percent of the of the final weight of the food product, between about 5 to about 10 percent, between about 8 to about 15 percent, between about 10 to about 15 percent, between about 15 and about 20 percent, about 5 to about 8 percent, between about 8 and about 13 percent and between about 12 and about 18 percent.

In embodiments where a fat replacement system has been added to the formulation for any particular frozen dessert food product, its content in the food product ranges between about 0.1 to about 10 percent of the of the final weight of the food product, between about 0.1 to about 2 percent, between about 0.2 to about 4 percent, between about 0.3 to about 5 percent, between about 0.5 and about 3 percent, between about 0.5 and about 5 percent, between about 1 and about 5 percent, about 1 to about 8 percent, between about 2 and about 5 percent, between about 2 and about 8 percent, between about 3 and about 5 percent, between about 3 and about 6 percent, between about 3 and about 9 percent, between about 4 and about 6 percent, between about 4 about 8 percent, between about 6 and about 8 percent, and between about 8 and about 10 percent.

In embodiments where a dairy replacement system has been added to the formulation for any particular frozen dessert food product, its content in the food product ranges between about 1 to about 20 percent of the final weight of the food product, between about 1 to about 5 percent, between about 1 to about 8 percent, between about 1 to about 12 percent, between about 2 to about 10 percent, between about 3 to about 13 percent, between about 5 to about 8 percent, between about 5 to about 10 percent, between about 5 to about 15 percent, between about 10 and about 13 percent, between about 8 to about 15 percent, between about 10 to about 15 percent, between about 15 and about 20 percent, and between about 12 and about 18 percent.

In embodiments where a emulsifiers and stabilizer system has been added to the formulation for any particular frozen dessert food product, its content in the food product ranges between about 0.1 to about 10 percent of the final weight of the food product, between about 0.1 to about 2 percent, between about 0.2 to about 4 percent, between about 0.3 to about 5 percent, between about 0.5 and about 3 percent, between about 0.5 and about 5 percent, between about 1 and about 5 percent, about 1 to about 8 percent, between about 2 and about 5 percent, between about 2 and about 8 percent, between about 3 and about 5 percent, between about 3 and about 6 percent, between about 3 and about 9 percent, between about 4 and about 6 percent, between about 4 about 8 percent, between about 6 and about 8 percent, and between about 8 and about 10 percent.

In embodiments where an anti-freezing and anti-caking system has been added to the formulation for any particular frozen dessert food product, its content in the food product ranges between about 0.1 to about 10 percent of the of the final weight of the food product, between about 0.1 to about 2 percent, between about 0.2 to about 4 percent, between about 0.3 to about 5 percent, between about 0.5 and about 3 percent, between about 0.5 and about 5 percent, between about 1 and about 5 percent, about 1 to about 8 percent, between about 2 and about 5 percent, between about 2 and about 8 percent, between about 3 and about 5 percent, between about 3 and about 6 percent, between about 3 and about 9 percent, between about 4 and about 6 percent, between about 4 about 8 percent, between about 6 and about 8 percent, and between about 8 and about 10 percent.

The combination of avocado and banana fruits (rich in lipids, sugars, saponins and phenolic acids) and coconut cream provide a creamy texture with desirable rheological parameters of consistency and viscosity for the ice cream products, as well as a very favorable freezing point for the ice cream products without the requirement for any animal fats, stabilizers, emulsifiers, and anti-freezing additives apart from those that are already provided and 100% based upon plant-derived ingredients.

The high-fat content of avocado within the agent with its rich presence of oleic acid (fatty acid) and phospholipid compounds (natural surfactants providing the texturizing properties) helped to mimic/provide similar functionalities as milk fat that are provided in conventional dairy-based ice creams, where the avocado aided in maintaining the whipping ability and homogeneity of the ice cream. Banana pulp, with its firmness and cohesiveness (resulting from the pectin polymer's content), fibrous texture, and good resistance to temperature fluctuations helped create a mix that contained the freezing and melting properties ideal for ice cream. The banana sugars also enhanced the sweet taste of the ice cream product.

Thus, the unique combination of essential ingredients as described herein and listed in Table 2, which are 100% plant-derived ingredients to replace the highly processed, artificial additives and conventional animal ingredients in foods, particularly ice cream and other frozen dessert products, meet the functionalities of animal and dairy based additives in food products while also providing nutritional benefits for the food products.

### Method of Preparation of the Plant-Only Bulking and Texturing System

i. At step 102, a) 10-50% by weight of a sugar or sugar replacement source, b) 3-15% by weight of a fat source, c) 1-20% by weight of a fruit puree source, d) 5-15% by weight of a fiber and protein source, e) 3-15% by weight of a starch source, and f) 3-15% by weight of a cream source is mixed in a blender at about 23° C. to 30° C. to obtain a first homogeneous mixture. At step 104, the first homogeneous mixture is pasteurized by continuous mixing for about 15-30 minutes at a temperature of 68-75 degrees Celsius to obtain the plant-only bulking and texturing system for food products.

In embodiments, the Monk fruit powder used as the sugar or sugar replacement source is produced by peeling the fruit and removing the seeds. The juice is collected by crushing the fruit. The juice is then dried to obtain the concentrated powder.

In embodiments, Avocado fruit is provided in the system as a mashed pulp, paste or puree by first separating the flesh of the avocado from its skin and seed and then mixing (e.g., in a blender or turbo mixer) for a suitable time to form a past or puree of a desired texture and consistency.

In embodiments, banana used as puree is obtained by separating the flesh of banana from peels followed by mashing.

In embodiments, Pea protein isolate used as the Fiber and protein source is produced by grounding dehulled dry peas into powder in a roller mill. The flour is dissolved in water at a ratio of 1:15 (w/v), and the pH of the resulting solution is raised to 8.5. After being agitated for one hour at room temperature, the solution is centrifuged at 6000 rpm for 20 minutes at 4° C. Whatman paper is used to filter the supernatant. To precipitate proteins, the resulting solution is centrifuged at 6000-8000 rpm for 10 minutes after having its pH adjusted to 4.5. The centrifuged pellet is collected and re-dissolved in water. The re-suspended solution's pH is brought back to 7.0. To obtain the protein isolate, the solution is spray dried. In embodiments, the protein isolation and concentration are done by solubilization and precipitation/filtration to separate it from the carbohydrate part.

In embodiments, Tapioca starch used as the plant-derived starch is prepared by cleaning, washing, peeling, and chopping cassava roots and feeding to a saw-tooth rasper for intense attrition into a pulpy slurry. Proteins, fibers etc. are further removed using extractors and centrifugation. Starch slurry exits the coarse extractor equipped with a filter cloth and a screen with an aperture of a finer screen (140-200 mesh). Filtered starch is recovered from the final starch stream and dried. In embodiments, to make the plant-derived starch, the fiber and protein part is solubilized and separated from starch using filtration/centrifugation.

In embodiments, Coconut cream used as the plant-derived cream is prepared by shredding ripe coconuts in a motorized rotary grater to separate the white meat from the shell. It is then blended at high speed with an equivalent volume of water (w/w). The cream is subsequently obtained by pressing the slurry through two layers of cheesecloth. In embodiments, the coconut cream is made by mixing the shredded coconut with water and homogenization. Further, the water layer is filtering out and the creamy layer is retained.

Merely for illustration, only representative number/type of graph, chart, block, and sub-block diagrams were shown. Many environments often contain many more block and sub-block diagrams or systems and sub-systems, both in number and type, depending on the purpose for which the environment is designed.

While specific embodiments of the disclosed embodiments have been shown and described in detail to illustrate the inventive principles, it will be understood that the disclosed embodiments may be embodied otherwise without departing from such principles.

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment” and similar language throughout this specification may, but do not necessarily, all refer to the same embodiment.

It should be understood that the figures and/or screen shots illustrated in the attachments highlighting the functionality and advantages of the disclosed embodiments are presented for example purposes only. The disclosed embodiments are sufficiently flexible and configurable, such that it may be utilized in ways other than that shown in the accompanying figures.

It should be understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference in their entirety for all purposes.

1. A plant-only bulking and texturizing system for food products comprising:
a) 10-50% by weight of a sugar or sugar replacement source, b) 3-15% by weight of a fat source, c) 1-20% by weight of a fruit puree source, d) 5-15% by weight of a fiber and protein source, e) 3-15% by weight of a starch source, and f) 3-15% by weight of a cream source.

2. The bulking and texturizing system of claim 1, wherein the sugar or sugar replacement source is selected from Banana, monk fruit powder, maple syrup, Custard apple, Raisins, Durian, Pears, Prunes, Sapodilla, Agave, Dried apricots, Date palm, Mangosteen, Barhi dates or combinations thereof.

3. The bulking and texturizing system of claim 1, wherein the fat source is selected from Avocado, Sunflower oil, Olive oil, mango kernel fat, Peanut oil, palm kernel oil, soybean oil, safflower oil, cocoa butter, corn oil, flaxseed oil, sesame oil or combinations thereof.

4. The bulking and texturizing system of claim 1, wherein the fruit puree is selected from Banana, Apple Puree, Avocado Puree, Pear Puree, Muskmelon Puree, Papaya Puree, Prunes Puree, apricot, mango puree, dragon fruit puree or combinations thereof.

5. The bulking and texturizing system of claim 1, wherein the fiber and protein source are selected from Chickpea, pinto beans, Corn fiber, black lentil, Citrus fiber, Balangu seed fiber, Psyllium fiber, Quince seed flour, Oat fiber, wheat germ, artichoke fiber, Pea fiber, Chicory root fiber or combinations thereof.

6. The bulking and texturizing system of claim 1, wherein the starch source is selected from Tapioca, Jackfruit seed starch, Taro starch, Yam starch, Arrowroot starch, Potato starch, Rice starch, Cassava starch, wheat starch, sweet potato starch or combinations thereof.

7. The bulking and texturizing system of claim 1, wherein the cream source is selected from Coconut cream, rice cream, cashew cream, sesame seeds cream, cassava cream, oat milk cream, white bean cream, tofu cream, three leaf yam cream, sweet potato cream, sunflower seeds cream or combinations thereof.

8. The bulking and texturizing system of claim 1, wherein the food product is a frozen dessert product, soft candies, Compound chocolates, Prebiotic cheese, Low calorie foods (meal replacement, pastries, breads), Low calorie frozen desserts and Non-dairy instant beverage powder.

9. A method of preparing a plant-only bulking and texturizing system for food products, wherein the method comprises:
mixing a) 10-50% by weight of a sugar or sugar replacement source, b) 3-15% by weight of a fat source, c) 1-20% by weight of a fruit puree source, d) 5-15% by weight of a fiber and protein source, e) 3-15% by weight of a starch source, and f) 3-15% by weight of a cream source in a blender at 18000-28000 RPM, at about 23° C. to 30° C. to obtain a first homogeneous mixture; and
pasteurizing the first homogeneous mixture by continuous mixing for about 15-30 minutes at a temperature of 68-75 degrees Celsius to obtain the plant-only bulking and texturing system for food products.

10. The method of claim 9, wherein the fruit puree source is immersed in lemon juice for about 15 minutes before mixing.

11. The method of claim 9, wherein the method comprises mixing the plant-only bulking and texturizing system with the food products to produce the bulking and texturizing effect to the food products.

12. The method of claim 9, wherein the food product is a frozen dessert product, soft candies, Compound chocolates, Prebiotic cheese, Low calorie foods (meal replacement, pastries, breads), Low calorie frozen desserts and non-dairy instant beverage powder.

13. The method of claim 9, wherein the sugar or sugar replacement source is selected from Banana, monk fruit powder, maple syrup, Custard apple, Raisins, Durian, Pears, Prunes, Sapodilla, Agave, Dried apricots, Date palm, Mangosteen, Barhi dates or combinations thereof.

14. The method of claim 9, wherein the fat source is selected from Avocado, Sunflower oil, Olive oil, mango kernel fat, Peanut oil, palm kernel oil, soybean oil, safflower oil, cocoa butter, corn oil, flaxseed oil, sesame oil or combinations thereof.

15. The method of claim 9, wherein the fruit puree is selected from Banana, Apple Puree, Avocado Puree, Pear Puree, Muskmelon Puree, Papaya Puree, Prunes Puree, apricot, mango puree, dragon fruit puree or combinations thereof.

16. The method of claim 9, wherein the fiber and protein source are selected from Chickpea, pinto beans, Corn fiber, black lentil, Citrus fiber, Balangu seed fiber, Psyllium fiber, Quince seed flour, Oat fiber, wheat germ, artichoke fiber, Pea fiber, Chicory root fiber or combinations thereof.

17. The method of claim 9, wherein the starch source is selected from Tapioca, Jackfruit seed starch, Taro starch, Yam starch, Arrowroot starch, Potato starch, Rice starch, Cassava starch, wheat starch, sweet potato starch or combinations thereof.

18. The method of claim 9, wherein the cream source is selected from Coconut cream, rice cream, cashew cream, sesame seeds cream, cassava cream, oat milk cream, white bean cream, tofu cream, three leaf yam cream, sweet potato cream, sunflower seeds cream or combinations thereof.

19. The method of claim 9, wherein physical characterization data associated with the ingredients of the bulking and texturing system comprising the sugar or sugar replacement source, the fat source, the fruit puree source, the fiber and protein source, the starch source, and the cream source is stored in a database, wherein a machine learning model determines a unique combination of ingredients based on the physical characterization data to prepare the bulking and texturing system.

20. The method of claim 19, wherein the physical characterization data of the ingredients comprise functional properties that comprise emulsification properties, stabilization properties, gelling properties, fat-replacement properties, Ayurvedic and/or other holistic properties, physicochemical properties that comprise pH, viscosity, moisture content, density, mechanical properties that comprise adhesive strength, tensile strength, shear resistance, chemical and/or molecular descriptor properties that comprise bio-active/bioavailability properties, molecular structure, phytonutrient properties, sensorial properties that comprise taste, smell, color, texture, mouth feel, and nutritional information that comprises macronutrient/micronutrient properties.
